(19) United States
(12) Patent Application Publication
(10) Pub. No.: US 2003/0091268 A1
(43) Pub. Date: May 15, 2003

(54) Optical switch having a retro-reflector positioned therein and a method of manufacturing therefor

(76) Inventors: Christopher J. Frye, Orefield, PA (US); Michael Hahn, Allentown, PA (US)

Correspondence Address: HITT GAINES & BOISBRUN P.C., P.O. BOX 832570, RICHARDSON, TX, 75083, US

(21) Appl. No.: 09/990,815

(22) Filed: Nov. 14, 2001

(51) Int. Cl. G02B 6/26

(52) U.S. Cl. 385/18

(57) ABSTRACT

The present invention provides an optical switch, a method of manufacture therefor and an optical communications system including the same. The optical switch may include a mirror and a retro-reflector optically alignable with the mirror. In one advantageous embodiment, the retro-reflector is positioned with respect to the mirror such that it redirects radiation reflecting off the mirror at a given angle back to the mirror at the given angle.

### TECHNICAL FIELD OF THE INVENTION

The present invention is directed, in general, to an optical switch and, more specifically, to an optical switch having a retro-reflector positioned therein, a method of manufacture therefor, and an optical communications system including the same.

### BACKGROUND OF THE INVENTION

Optical switches are currently gaining widespread use in today's ever competitive optical communications markets. One particular optical switch that is quickly gaining widespread use is an all-optical switch. All-optical switches provide certain benefits that may not be provided in many electronic switches, and as such, all-optical switches are very desirable.

All-optical switches currently use several methods to switch optical signals from one optical waveguide to another. Most of these methods include the use of mirrors. One notable design uses silicon processing to create movable “pop-up” mirrors on the surface of a silicon wafer. This design can be used to route radiation within a single plane. Using this design, one mirror is required for each connection. For example, if the all-optical switch connects n inputs to n outputs, then n² mirrors would be required. Because of limitations on the size of the mirrors and the processing involved, the area of the chip or wafer on which the mirrors are micro-machined is extremely large, and therefore, limits the expandability of the pop-up mirror switches.

Another notable design uses beam steering mirrors that rotate on two axes. Because the beam steering mirrors rotate on two axises, a reduced number of mirrors may be used to switch the same number of waveguides. For example, if a switch having beam steering mirrors connects n inputs to n outputs, then 2n beam steering mirrors might be required. While a smaller number of beam steering mirrors might be required to switch the same number of inputs and outputs, each individual beam steering mirror requires more chip or wafer area than a single pop-up mirror. As such, chip or wafer area problems still exist when using the beam steering mirrors. Additionally, the beam steering mirrors tend to be more difficult to assemble than pop-up mirrors.

Accordingly, what is needed in the art is an optical switch and a method of manufacture therefor that does not experience the problems experienced by the prior art optical switches.

### SUMMARY OF THE INVENTION

To address the above-discussed deficiencies of the prior art, the present invention provides an optical switch having a retro-reflector positioned therein, a method of manufacture therefor and an optical communications system including the same. The optical switch may include a mirror and a retro-reflector optically alignable with the mirror. In one advantageous embodiment, the retro-reflector is positioned with respect to the mirror such that it redirects radiation reflecting off the mirror at a given angle, back to the mirror at the given angle.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

The invention is best understood from the following detailed description, when read with the accompanying FIGUREs. It is emphasized that in accordance with the standard practice in the optoelectronic industry, various features may not be drawn to scale. In fact, the dimensions of the various features may be arbitrarily increased or reduced for clarity of discussion. Reference is now made to the following descriptions taken in conjunction with the accompanying drawings, in which:

FIG. 1 illustrates a cross-sectional view of an optical switch, which has been constructed according to the principles of the present invention;

FIG. 2 illustrates a plan view of the optical switch shown in FIG. 1;

FIG. 3 illustrates an optical communications system, which may form one environment where an optical switch, similar to the optical switch shown in FIG. 1, may be included;

FIG. 4 illustrates an alternative optical communications system; and

FIG. 5 illustrates an alternative optical communications system including a repeater, a second receiver, a second transmitter located between a first receiver and a first transmitter.

### DETAILED DESCRIPTION

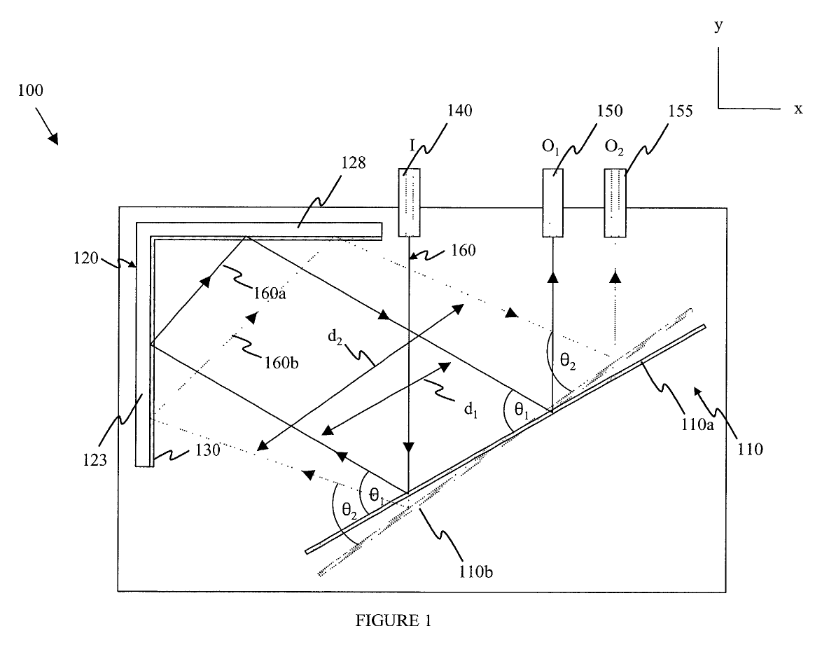

Referring initially to FIG. 1, illustrated is a cross-sectional view of an optical switch 100, which has been constructed according to the principles of the present invention. In the illustrative embodiment shown in FIG. 1, the optical switch 100 includes a mirror 110. The mirror 110 may be any reflective element that is consistent with the design of the optical switch 100. For example, in an exemplary embodiment, the mirror 110 is a rotatable mirror. Additionally, the mirror 110 may be a micro-electro-mechanical system (MEMS) mirror, or alternatively, a 2-dimensional beam-steering mirror. While certain examples for the mirror 110 have been given, it should be understood that any reflective surface capable of reflecting radiation, is within the scope of the present invention.

The optical switch illustrated in FIG. 1 further includes a retro-reflector 120. As illustrated, the retro-reflector 120 is optically aligned with the mirror 110, such that it redirects radiation reflecting off the mirror 110 at a given angle, back to the mirror 110 at the given angle.

The retro-reflector 120 may comprise many different structures. In one particular embodiment, the retro-reflector 120 comprises two substantially perpendicular surfaces 123, 128, (e.g., a 2-dimensional retro-reflector) wherein an inner surface of each of the perpendicular surfaces 123, 128, has a reflective coating 130 located thereon. The term “substantially perpendicular” means that the two surfaces 123, 128 intersect one another at about a 90° angle. In one advantageous embodiment, the two substantially perpendicular surfaces 123, 128 are two individual surfaces that are substantially rigid with respect to one another. In a more advantageous embodiment, however, the two substantially perpendicular surfaces 123, 128 form a single rigid and contiguous structure, e.g, a single rigid and contiguous retro-reflector 120. Because the two substantially perpendicular surfaces 123, 128 may form a single rigid and contiguous structure, many of the accuracy and control issues experienced by the prior art structures are limited. For example, there would be only limited concern that two substantially perpendicular surfaces 123, 128 would rotate with respect to one another.

In an alternative embodiment, however, the retro-reflector 120 may comprise a cone or a corner cube (e.g., a 3-dimensional retro-reflector) having the reflective coating 130 on an inner surface thereof. The cone, similar to the perpendicular surfaces 123, 128 discussed above, may be formed such that any two opposing surfaces are substantially perpendicular to one another. For example, in an exemplary embodiment, a right isosceles circular cone may be used. By using the cone or corner cube, rather than the perpendicular surfaces 123, 128 discussed above, a larger range of switching alternatives may be obtained.

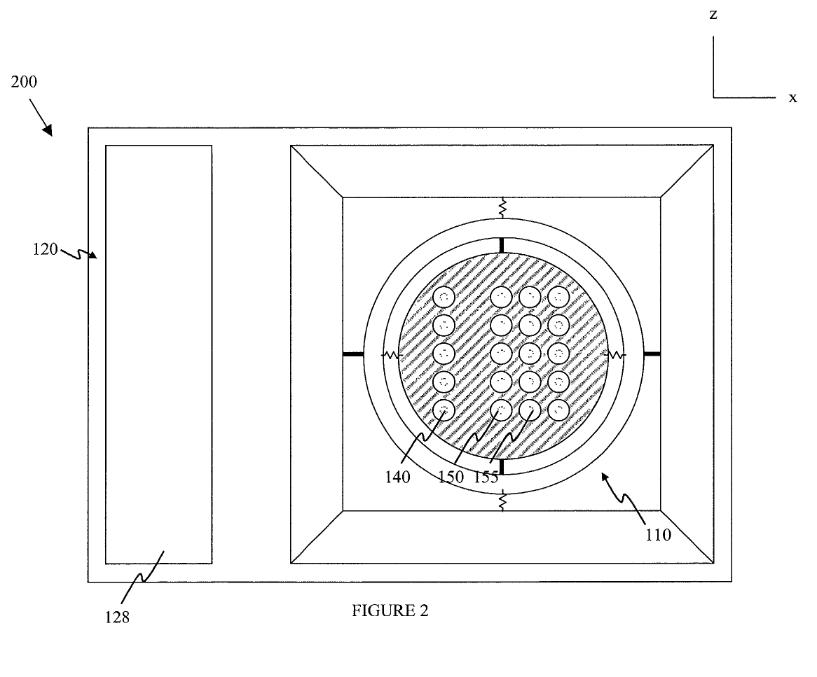

Turning briefly to FIG. 2, illustrated is a plan view of the optical switch 100 shown in FIG. 1. Included with the plan view shown in FIG. 2 is the mirror 110, which in the particular embodiment shown happens to be a 2-dimensional MEMS beam steering mirror, and the retro-reflector 120. The plan view further illustrates input waveguides 140 and output waveguides 150, 155.

A method of operating the optical switch 100 illustrated in FIGS. 1 and 2, will now be discussed. It should be noted, that while the following method of operating the optical switch 100 will be referring to the input waveguide 140 and output waveguides 150, 155, whether a waveguide is designated as input or output depends solely on what direction radiation 160 is traveling with respect to the optical switch 100 and the waveguides 140, 150, 155. In the current example, the input waveguide 140 is providing the radiation 160 to the mirror 110 and the output waveguides 150, 155 are accepting redirected radiation 160 from the mirror 110.

Two operational situations will now be used to discuss the method of operating the optical switch 100. In the first situation, the mirror 110 is positioned at a first rotational angle 110a. Alternatively, in the second situation, the mirror is positioned at a second rotational angle 110b. In an exemplary embodiment, the first rotational angle 110a is achieved when the mirror 110 is in an un-actuated state, and the second rotational angle 110b is achieved when the mirror 110 is in an actuated state. It should be noted, however, that this may not always be the case, and that in certain alternative embodiments the first rotational angle 110a may be achieved when the mirror 110 is in a partially actuated state, and the second rotational angle 110b may be achieved when the mirror 110 is in a fully actuated state.

In the first situation, input radiation 160a is imparted on the mirror 110, which as previously recited, happens to be located at the first rotational angle 110a. As the radiation 160a encounters the mirror 110, the mirror 110 reflects the radiation 160a to the retro-reflector 120. As illustrated, the radiation 160a reflects off the mirror 110 at a first angle (θ₁) and encounters the retro-reflector surface 123. The retro-reflector surface 123 then reflects the radiation 160a to the retro-reflector surface 128, wherein it is reflected back to the mirror 110. Note that the retro-reflector surface 128 reflects the radiation 160a back to the mirror 110 at the first angle (θ₁). Note also that the radiation 160a being reflected from the mirror 110 to the retro-reflector surface 123 is parallel with the radiation 160a being reflected from the retro-reflector surface 128 to the mirror 110. As illustrated, the redirected radiation 160a encounters the mirror 110 at a lateral offset distance (d₁). The mirror 110 then reflects the radiation 160a to the output waveguide 150, whereby a switch of the radiation 160a from the input waveguide 140 to the output waveguide 150 has occurred.

In the second situation, input radiation 160b is imparted on the mirror 110, which as previously recited, happens to be located at the second rotational angle 110b. As the radiation 160b encounters the mirror 110, the mirror 110 reflects the radiation 160b to the retro-reflector 120. As illustrated, the radiation 160b reflects off the mirror 110 at a second angle (θ₂) and encounters the retro-reflector surface 123. Since the mirror 110 is located at the rotated position 110b, the first angle (θ₁) and the second angle (θ₂) are different from one another. The retro-reflector surface 123 then reflects the radiation 160b to the retro-reflector surface 128, wherein it is reflected back to the mirror 110. Note that the retro-reflector surface 128 reflects the radiation 160b back to the mirror 110 at the second angle (θ₂). Note also that the radiation 160b being reflected from the mirror 110 to the retro-reflector surface 123 is parallel with the radiation 160b being reflected from the retro-reflector surface 128 to the mirror 110. As illustrated, the redirected radiation 160b encounters the mirror 110 at a lateral offset distance (d₂). In the current example, the lateral offset distance (d₂) is greater than the lateral offset distance (d₁), however, this may vary depending on the second rotational angle 110b. The mirror 110 then reflects the radiation 160b to the output waveguide 155, whereby a switch of the radiation 160b from the input waveguide 140 to the output waveguide 155 has occurred.

While the method of operating the optical switch 100 has currently only been described with respect to two situations having only two rotational angles, it should be understood that the mirror 110 may be rotated to any angle about either axis that might me necessary to achieve a desired optical path. As such, the optical switch 100 may be used to redirect radiation exiting a single input waveguide to an unlimited number of output waveguides. Additionally, the optical switch may be used to attenuate or drop the radiation, depending on a location where the radiation is redirected.

The optical switch 100 in accordance with the principles of the present invention provides many advantages not provided by the prior art optical switches. For example, the optical switch reduces the number of mirrors required to switch an optical signal from a single input waveguide to any one of a plurality of output waveguides. Additionally, the optical switch is easy to assemble. For example, in many situations the mirror and retro-reflector self-align themselves to one another. Moreover, the optical switch requires less precise control than many of the prior art optical devices.

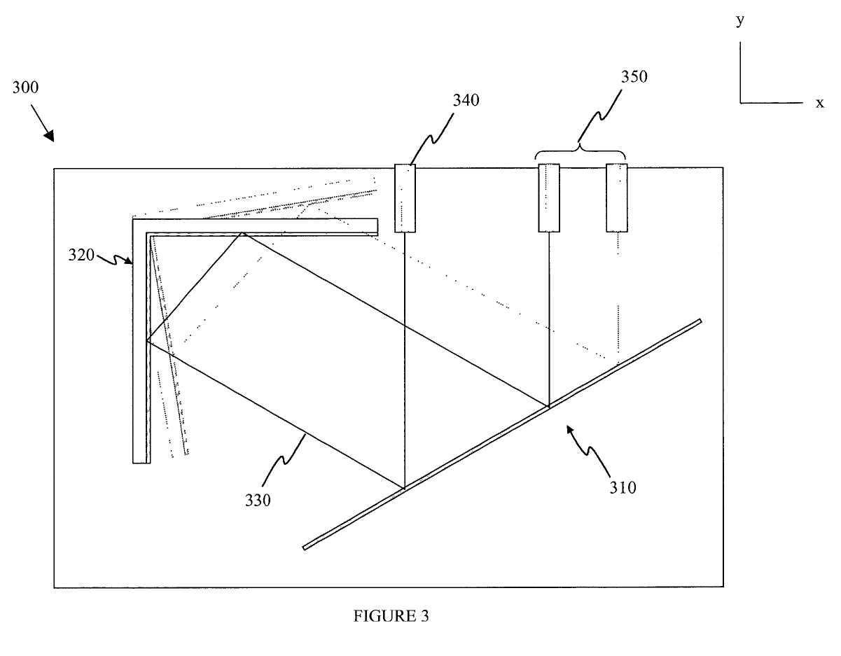

Turning to FIG. 3, illustrated is a cross-sectional view of an alternative embodiment of an optical switch 300, which is in accordance with the principles of the present invention. In the illustrative embodiment shown in FIG. 3, a mirror 310 is rigid (not rotatable) and a retro-reflector 320 is rotatable. Similar to the embodiments discussed above with respect to FIGS. 1 and 2, radiation 330 may be switched from an input waveguide 340 to one of a plurality of output waveguides 350 by rotating the retro-reflector to different angles.

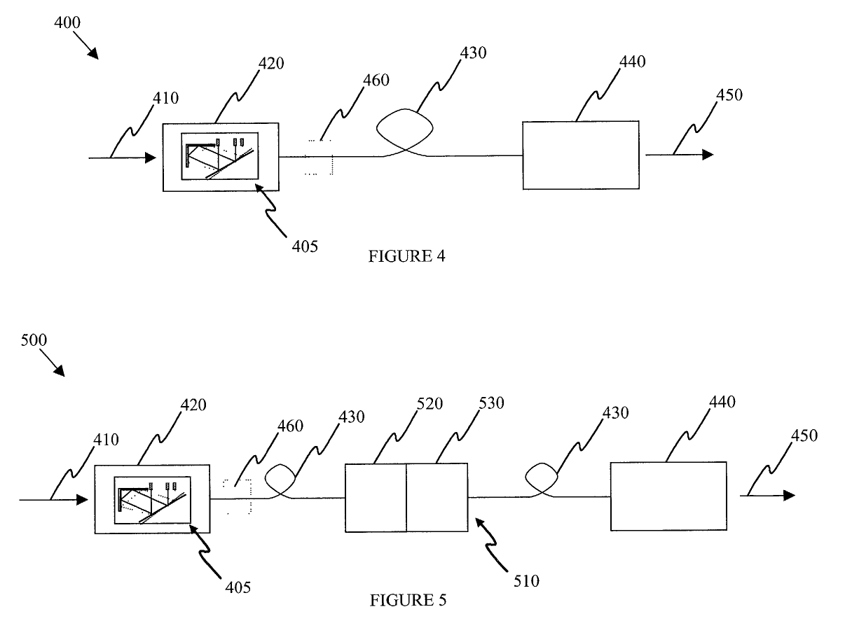

Turning to FIG. 4, illustrated is an optical communications system 400, which may form one environment where an optical switch 405, similar to the optical switch 100 shown in FIG. 1, may be included. The optical communications system 400, in the illustrative embodiment, includes an initial signal 410 entering a receiver 420. The receiver 420, receives the initial signal 410, addresses the signal 410 in whatever fashion desired, and sends the resulting information across an optical fiber 430 (or plurality of fibers) to a transmitter 440. The transmitter 440 receives the information from the optical fiber 430, addresses the information in whatever fashion desired, and sends an ultimate signal 450. As illustrated in FIG. 4, the optical switch 405 may be included within the receiver 420. However, the optical switch 405 may also be included anywhere in the optical communications system 400, including the transmitter 440. The optical communications system 400 is not limited to the devices previously mentioned. For example, the optical communications system 400 may include a source 460, such as a laser or a diode. The optical communications system 400 may further include various other lasers, photodetectors, optical amplifiers, transmitters, and receivers.

Turning briefly to FIG. 5, illustrated is an alternative optical communications system 500, having a repeater 510, including a second receiver 520 and a second transmitter 530, located between the receiver 420 and the transmitter 440.

Although the present invention has been described in detail, those skilled in the art should understand that they can make various changes, substitutions and alterations herein without departing from the spirit and scope of the invention in its broadest form.

What is claimed is:

1. An optical switch, comprising:
a mirror; and
a retro-reflector optically alignable with the mirror such that the retro-reflector redirects radiation reflecting off the mirror at a given angle back to the mirror at the given angle.

2. The optical switch as recited in claim 1 wherein the mirror is a rotatable mirror.

3. The optical switch as recited in claim 1 wherein the mirror is a micro-electro-mechanical system mirror.

4. The optical switch as recited in claim 3 wherein the micro-electro-mechanical system mirror is a 2-dimensional beam-steering mirror.

5. The optical switch as recited in claim 1 wherein the retro-reflector comprises two perpendicular reflective surfaces.

6. The optical switch as recited in claim 1 wherein the retro-reflector comprises a right isosceles circular cone or a corner cube.

7. The optical switch as recited in claim 1 wherein the retro-reflector is rotatable.

8. A method of manufacturing an optical switch, comprising:
providing a mirror; and
optically aligning a retro-reflector with respect to the mirror such that the retro-reflector redirects radiation reflecting off the mirror at a given angle back to the mirror at the given angle.

9. The method as recited in claim 8 wherein providing a mirror includes providing a rotatable mirror.

10. The method as recited in claim 8 wherein providing a mirror includes providing a micro-electro-mechanical system mirror.

11. The method as recited in claim 10 wherein providing a micro-electro-mechanical system mirror includes providing a micro-electro-mechanical system 2-dimensional beam-steering mirror.

12. The method as recited in claim 8 wherein optically aligning a retro-reflector includes optically aligning a retro-reflector comprising two perpendicular reflective surfaces.

13. The method as recited in claim 8 wherein optically aligning a retro-reflect or includes optically aligning a retro-reflector comprising a right isosceles circular cone or a corner cube.

14. The method as recited in claim 8 wherein optically aligning a retro-reflector includes optically aligning a rotatable retro-reflector.

15. An optical communications system, comprising:
an optical switch, comprising;
a mirror; and
a retro-reflector optically alignable with the mirror such that the retro-reflector redirects radiation reflecting off the mirror at a given angle back to the mirror at the given angle; and
a plurality of waveguides optically coupled to the optical switch and configured to transmit radiation.

16. The optical communications system as recited in claim 15 wherein the mirror is a micro-electro-mechanical system mirror.

17. The optical communications system as recited in claim 16 wherein the micro-electro-mechanical system mirror is a 2-dimensional beam-steering mirror.

18. The optical communications system as recited in claim 15 wherein the retro-reflector comprises two perpendicular reflective surfaces.

19. The optical communications system as recited in claim 15 wherein the retro-reflector comprises a right isosceles circular cone or a corner cube.

20. The optical communications system as recited in claim 15 further including devices coupled to the optical switch that are selected from the group consisting of:
lasers,
photodetectors,
optical amplifiers,
transmitters, and
receivers.
